(19) United States
(12) Patent Application Publication
(10) Pub. No.: US 2004/0043195 A1
(43) Pub. Date: Mar. 4, 2004

(54) Thermoprinted labels for mats

(76) Inventors: Amy B. Streeton, Lagrange, GA (US); Michael L. Keeter, Pine Mountain, GA (US)

Correspondence Address: Terry T. Moyer, P. O. Box 1927, Spartanburg, SC, 29304, US

(21) Appl. No.: 10/230,032

(22) Filed: Aug. 28, 2002

(51) Int. Cl. B32B 3/00; B32B 31/00

(52) U.S. Cl. 428/156; 156/277

(57) ABSTRACT

The present disclosure relates to a permanent identification marking, which preferably comprises a thermally printed label, affixed to a rubber or rubber-like flooring article during vulcanization. The label is made from either thermoplastic elastomer or the same rubber material as the flooring article. Further, a process for producing such marked flooring articles is provided, consisting of providing a die-cut label blank, thermally printing the die-cut label, positioning such label in a desired location on one surface of a flooring article, and vulcanizing the flooring article to produce a finished flooring article and to secure the label to the surface thereof. Specifically, a process for producing mass-customized labels useful for identifying rubber floor mats is described.

### TECHNICAL FIELD

The present disclosure relates to a permanent identification marking, which preferably comprises a thermally printed thermoplatic elastomer label, affixed to a rubber or rubber-like flooring article during vulcanization. Further, a process for producing such marked flooring articles is provided, consisting of providing a die-cut label blank, thermally printing the die-cut label, positioning such label in a desired location on one surface of a flooring article, and vulcanizing the flooring article to produce a finished flooring article and to secure the label to the surface thereof. Specifically, a process for producing mass-customized labels useful for identifying rubber floor mats is described.

### BACKGROUND

It is known to mark any such rubber article with letters, figures, signs, and/or bar coding information by making indentations or elevations (that correspond to the desired indicia) in the rubber article. The problem found with such embossing or engraving is that elevations tend to be worn away quickly with use, while indentations tend to weaken the article at the indented points. Further, it is difficult, if not impossible, in terms of feasibility, to produce customized labels for mass production.

Another means for marking such articles is to use screen printing techniques or film printing. A drawback to these approaches is that the marking is easily worn away as the rubber article is worn. A related approach uses thermoplastic elastomer, which is die cut into the desired letters, signs, figures, and the like and which is then attached to the vulcanized product. This approach is time consuming and the amount of information that can be displayed using this technique is limited due to the manual-intensive cutting process. Additionally, it is difficult to position the segmented indicia without misaligning or losing parts of the letters, signs, figures, or the like.

Yet another technique for marking is described in U.S. Pat. No. 4,902,554 to Lang, in which a label is made in the form of a plastic foil which is printed with at least one printing ink of vulcanizable rubber material, the imprint being in the form of inverted letters, signs, digits, and/or figures. An obvious difficulty with this method is the generation of inverted text and images, and, specifically, with the generation of customizable indicia, as might be varied from mat-to-mat.

Bar code labeling alone, such as described in U.S. Pat. No. 4,929,820 to Jesperson, does not fulfill customer preferences for inclusion of identifying product or manufacturer information. Additionally, the bar coding method described therein indents or perforates the mat surface in the creation of the bars, thus weakening the overall product.

Finally, many mats have been labeled with paper stickers that are printed with the desired information and secured to the mat surface with adhesive. Such labels are not durable and are incapable of withstanding industrial laundering conditions. In some instances, the adhesive leaves an undesirable sticky film on the mat surface to which it was applied. In any event, paper-based labels are merely a temporary solution to the identification problem.

It would be desirable, therefore, to have a means for permanently adding customizable indicia to the reverse side of a rubber article, such as a floor mat. The present disclosure describes such a process for producing mass-customizable labels that are thermoprinted and that are affixed to a rubber flooring article, preferably during vulcanization of the article.

It is an object of the present process to create customizable labels suitable for application to a vulcanizable flooring article, these labels including customer, manufacturer, and/or product information, which is represented by letters, numbers, signs, and the like.

It is another object to provide a durable label that is produced quickly and economically.

Yet a further object is to provide means for marking flooring articles with identifying characters and/or signs, such these marked articles may be appropriately handled, sorted, and shipped.

### SUMMARY

A permanent identification label, which comprises a thermally printed piece of thermoplastic elastomer or rubber, is provided herein. Such a printed label is affixed to a rubber or rubber-like flooring article (e.g., a mat) during vulcanization. Further, a process for producing such marked flooring articles is provided, consisting of providing a die-cut label blank, thermally printing the die-cut label, positioning such label in a desired location on one surface of a flooring article, and vulcanizing the flooring article to produce a finished flooring article and to secure the label to the surface thereof. Specifically, a process for producing mass-customized labels useful for identifying rubber floor mats is described.

### BRIEF DESCRIPTION OF THE DRAWINGS

FIG. 1A is a plan view of the rear side of a rubber flooring article, having cleats projecting from the surface thereof and further having an identification label placed in the border area thereof;

FIG. 1B is a plan view of the rear side of a rubber flooring article, having cleats projecting from the surface thereof and further having an identification label placed in the interior portion thereof; and

FIG. 2 is a plan view of the rear side of a rubber flooring article, having a substantially smooth surface and showing the placement of an identification label thereon.

### DETAILED DESCRIPTION

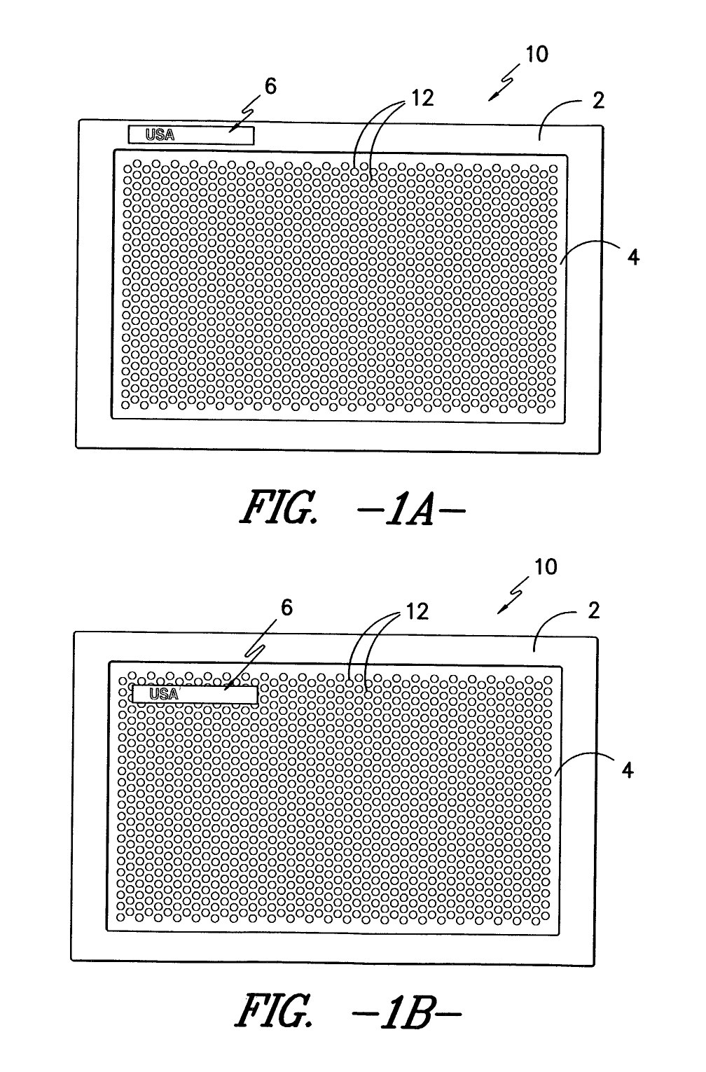

As shown in FIG. 1A, a rubber flooring article 10 is provided. In this representative drawing, the rear side of article 10 is illustrated as having a perimeter border 2 and an interior portion 4 with a plurality of outwardly projecting cleats 12. An identification label 6 is positioned in perimeter area 2, thus preserving the integrity of label 6 during vulcanization (that is, label 6 is not impacted by the production of cleats 12).

Alternatively, however, it is not required to position label 6 in perimeter area 2. As shown in FIG. 1B, label 6, which may be configured to any size, is adaptable for use over cleats 12 in interior portion 4. The printing used on label 6 is of sufficient size that the printing remains legible, even after the formation of cleats 12.

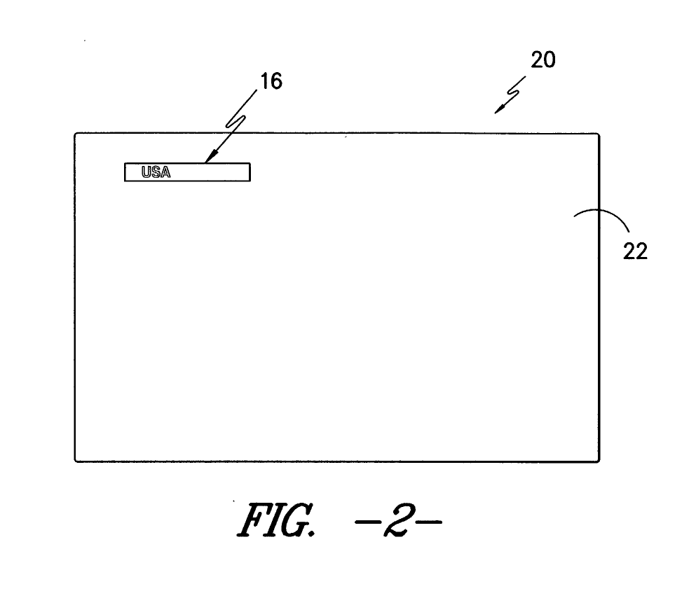

FIG. 2 shows an alternate construction of flooring article 10. Flooring article 20 has a substantially smooth rear surface 22. It should be noted that the face surface of article 22 may contain a plurality of cleats (similar to those shown on the rear of article 10) or may comprise a textile face component (not shown), which is tufted, bonded, woven, or nonwoven. As illustrated, identification label 16 is positioned in any desired location on surface 22. Label 16 may be larger than label 6, because of the greater expanse of substantially smooth surface area to which label 16 may be applied. One particularly preferred size for label 16 has been found to be about 1.75 inches by about 8 inches.

Flooring articles 10, 20 are preferably comprised of any vulcanizable rubber substance, including, but not limited to, acrylonitrile butadiene rubber (NBR), styrene butadiene rubber (SBR), ethylene propylene diamine monomers (EPDM), and combinations of any of the above. Additionally, any article having a rubber or rubber-like surface to which labels 6, 16 may be adhered is suitable for use with the present product (e.g., thermoplastic elastomers).

Labels 6, 16 are preferably formed of a thermoplastic elastomer, which has a smooth surface that is printed with desired indicia using a thermal printing apparatus. Labels 6, 16 may have a glossy or matte surface, although better printing results are achieved by using thermoplastic elastomer having a glossy surface. An alternative to thermoplastic elastomer is to use a thin strip of the same rubber material as flooring article 10, 20, such as, by way of example, acrylonitrile butadiene rubber (NBR), styrene butadiene rubber (SBR), ethylene propylene diamine monomers (EPDM), and combinations of any of the above. In particular, partially curing the rubber material that will become labels 6, 16 extends the shelf-life of the uncured rubber.

One particularly suitable apparatus for printing labels 6, 16 is a black-and-white thermal transfer printer of the T5000 series produced by Printronix of Irvine, Calif. The thermal transfer printer employs a resin/wax thermal transfer ribbon. It has been found, however, that this printing apparatus is capable of printing complex and aesthetically pleasing labels on thermoplastic elastomer. Such labels 6, 16 may include manufacturing information, product information, and/or customer information. Bar coding information may also be included. Labels 6, 16 may further include a plurality of ink colors and/or designs, logos, letters, or symbols, although a color thermal printer would be required to achieve such results. Similar printers are typically used to print bumper stickers, window decals, iron-on patches for apparel, and the like.

Labels 6, 16 may be of any dimension desired by the manufacturer or the customer. The thermoplastic elastomer (or rubber material) is positioned on a carrier paper to facilitate the movement of the label material through the printing apparatus. The thickness of the carrier paper is not significant, so long as the combination of the carrier paper and label material moves smoothly through the printing apparatus. The carrier “paper” may be paper, coated paper, mylar, any polymeric plastic (e.g., polypropylene, polyethylene, and the like), or any other suitable material, depending on the printing apparatus. The thickness of the label material varies depending on the printing apparatus used. Representative thicknesses of thermoplastic elastomer range from about 0.005 inches to about 0.05 inches. One preferred thermoplastic elastomer thickness, when using the Printronix printing apparatus described above, is about 0.01 inches.

Labels 6, 16 are produced by first entering the desired indicia into a data processing software program. The indicia are then printed onto the thermoplastic elastomer, which is die cut to the preferred label dimensions. The printed label (6, 16) is positioned on the rubber article 10, 20 in a desired location, preferably before vulcanization. During vulcanization, rubber article 10, 20 is vulcanized and the thermoplastic elastomer softens and is pushed into the surface of the rubber article. The result is a rubber article 10, 20 having a permanently affixed, durable label 6, 16, on which is printed identifying information. An article marked in such a way represents an advancement over the prior art.

What is claimed is:

1. A vulcanized rubber floor mat comprising a face surface, a backing surface, and a label vulcanized to said backing surface, said label having been thermally printed with indicia being selected from the group consisting of letters, numbers, characters, symbols, and combinations thereof.

2. The floor mat of claim 1, wherein said label is comprised of thermoplastic elastomer.

3. The floor mat of claim 2, wherein said label has a thickness, before vulcanization, of about 0.01 inches.

4. The floor mat of claim 1, wherein said indicia printed on said label is selected from the group consisting of manufacturer information, product information, customer information, and combinations thereof.

5. The floor mat of claim 4, wherein said indicia printed on said label further includes bar coding information.

6. The floor mat of claim 1, wherein said face surface comprises a textile material.

7. The floor mat of claim 1, wherein said face surface comprises a plurality of cleats projecting from said surface thereof.

8. The floor mat of claim 1, wherein said backing surface comprises a plurality of cleats inward of a non-cleated perimeter border, said label being vulcanized to said border.

9. A process for producing vulcanized flooring articles that comprise a face surface, a backing surface, and a label vulcanized to said backing surface, said process comprising the steps of:
(a) providing a label blank comprised of a label material, said label material being selected from the group consisting of thermoplastic elastomer, acrylonitrile rubber, styrene butadiene rubber, ethylene propylene diamine monomer, and combinations thereof;
(b) thermally printing said label blank to create a printed label;
(c) positioning said printed label on said backing surface of said flooring article; and
(d) vulcanizing said flooring article and said printed label to produce a vulcanized flooring article having said printed label thereon.

10. The process of claim 9, wherein said label blank is thermoplastic elastomer.

11. The process of claim 9, wherein said thermal printing is accomplished by a thermal transfer printer having a resin/wax thermal transfer ribbon.

12. The process of claim 9, wherein said printed label includes indicia selected from the group consisting of letters, numbers, symbols, characters, bar codes, and combinations thereof.

13. The process of claim 9, wherein said flooring article is comprised of a rubber selected from the group consisting of acrylonitrile rubber, styrene butadiene rubber, ethylene propylene diamine monomer, and combinations thereof.

14. The process of claim 13, wherein said flooring article is comprised of acrylonitrile rubber.

15. The process of claim 14, wherein said label is comprised of acrylonitrile rubber.

16. The process of claim 15, wherein said label is partially cured before step (b).
